(19) United States
(12) Patent Application Publication
(10) Pub. No.: US 2015/0059922 A1
(43) Pub. Date: Mar. 5, 2015

(54) Container With Electronically Controlled Interlock

(71) Applicant: Proteus Digital Health, Inc., East Palo Alto, CA (US)

(72) Inventor: Andrew Thompson, Portola Valley, CA (US)

(21) Appl. No.: 14/469,381

(22) Filed: Aug. 26, 2014

Related U.S. Application Data
(60) Provisional application No. 61/872,454, filed on Aug. 30, 2013.

(51) Int. Cl. B67D 7/34; B65D 49/00

(52) U.S. Cl. CPC B67D 7/34; B65D 49/00
USPC 141/94

(57) ABSTRACT

The apparatus and methods of the current invention utilize a container having an interlock that prevents filling the container, dispensing from the container, or both, as well as a detecting mechanism that senses a unique identifier associated with a particular product allowing its use in conjunction with the container.

### CROSS-REFERENCE TO RELATED APPLICATIONS

This application claims the benefit under 35 USC §119(e) of U.S. Provisional Application No. 61/872,454 titled “Container with Electronically Controlled Interlock,” filed Aug. 30, 2013, the disclosure of which application is herein incorporated by reference.

### INTRODUCTION

Containers that can be filled, emptied, and refilled are attractive to consumers for a variety of reasons. Besides cutting down on post-consumer waste, reusable containers can also be customized for a variety of purposes. The customization may range from attractive aesthetic design, to specialized shapes and sizes based on what is to be contained and where the container might be used or mounted. “Smart” or “digital” containers offering a wide range of high tech uses besides simply serving as a receptacle for various materials.

Supplying a customized reusable container for use with a particular product or line of products may be a valuable marketing strategy for suppliers of various consumable products. A potential downfall with this strategy is the potential for the consumer to use the customized container to hold products other than what was intended, perhaps even the products of competitors, or unsafe or dangerous products. Therefore it would be desirable to have a customizable container that is restricted for use to a particular product or line of products.

For example, a supplier of a beverage used by avid bicyclists might want to attract potential purchasers by providing an attractive custom designed bottle that could be mounted on a bicycle. The problem is that once the customized bottle is purchased or even given away to the consumer, there is nothing that would prevent the consumer from later using the bottle with a competitor's beverage or simply even water. The marketing strategy would be more desirable for the beverage supplier if the bottle itself could restrict its use to only the beverages or lines of beverages of that particular supplier.

Another example of a customizable container might be a “smart” container capable of monitoring how much material enters or is expelled from the container. Such a container may be useful to someone interested in tracking the amount of food, drink, medication, or supplements ingested by the user of the container. An alternative use for this type of customization could also be using the container as a measuring device, i.e. instead of using a measuring spoon or cup the material could be measured as poured. The customized container may also monitor or measure calories ingested by the user of the container as or when a portion of the contents of the container is consumed.

Further customization could include a container that tracks the time and date materials or product are placed inside a container as well as when the contents are ultimately removed, e.g., consumed.

Should such containers exist, they would not just be attractive marketing tools for suppliers of beverages, but could be used with other ingestible items such as dried cereal, medication, gumballs, candy, pet food, spices, and baking supplies. They could also be attractive for suppliers of items such as laundry soap, shampoo, and cleaning supplies.

Logically speaking, the more customized and attractive the container, the more expensive it may be. Therefore, the option for recouping that cost may be limited to either charging more for the container itself, or spreading the cost recovery over time with the price of the consumable to be placed within the container. Recovering the cost by linking it to supplying the consumable instead of to a one-time purchase price of the container may result in higher profits in the long run. In order to maximize the continual purchasing of a particular product to be used with the container, it would be extremely helpful to restrict a container's use to only a particular product or line of products belonging to the container's supplier.

### SUMMARY

The following aspects of the invention are described and illustrated in conjunction with systems, tool and methods which are meant to be exemplary and illustrative, not limiting in scope.

The apparatus and methods of the invention utilize a container having an interlock that prevents filling the container, dispensing from the container, or both, as well as a detecting mechanism that senses a unique identifier associated with a particular product allowing its use in conjunction with the container.

One aspect of the apparatus of the invention includes a container, for example, a bottle, that has a device which prevents material such as a sports energy drink (also referred to as an electrolyte replacement beverage) from being poured into the bottle, unless an interlock device is activated which allows the bottle to be opened for filling.

Another aspect of the apparatus of the invention includes a container, for example, a bottle, that has a device which permits material to enter the bottle, such as a sports energy drink. However, the bottle contains an interlock device which prevents the contents of the bottle from being expelled from the bottle in a convenient or useful manner, unless the interlock device is properly activated. In some aspects of the invention, where the interlock device prevents material from exiting the bottle, there may be a secondary exit valve which may be opened, for example on the side of the bottle, or at the bottom of the bottle, which would allow the bottle to be emptied or cleaned, in the absence of the successful operation of the interlock device. This would also allow for thermal expansion relief, for example, in the event that a carbonated beverage develops pressure requiring release. As can be appreciated, the secondary opening/exit valve would be less desirable to use than the intended opening controlled by the interlock device.

The interlock devices of various aspects of the invention may operate and be controlled in a variety of different ways depending on the application and needs of a particular container. In many cases the interlock device would be controlled by a system of sensors and unique identifiers (IDs) followed by an analysis of whether a unique identifier is acceptable. Depending on the result of the analysis, an instruction is communicated to the interlock device, either opening it, or causing it to remain closed. It should be appreciated that a different method of the invention would simply not communicate a message at all to the interlock device if a unique identifier is deemed unacceptable or is rejected.

An exemplary aspect of the invention includes a customized container with a sensor and an interlock that is operated by first sensing a unique identifier that is associated in some way with a product that the user intends to fill the customized container. If a unique identifier of the product sensed and is deemed acceptable through an analysis after it sensed then an instruction is provided to the interlock to open thereby allowing the user to transfer the product into the customized container.

In an aspect of the invention, the customized container is a bottle. The desired product may also be contained in a bottle, having a cap which is capable of being re-attached once it is removed. In this aspect of the invention, the cap may contain the unique identifier. The method of an aspect of the invention may include the step of removing the cap with a unique identifier from the bottle of the desired product. The cap is then attached to a portion of the customized bottle (for example a threaded receiver) that provides a sensor for sensing the unique identifier contained upon the cap. If a unique identifier is sensed and an analysis indicates that the unique identifier is acceptable, an instruction is provided to the interlock to open, allowing the desired product to enter the customized container. Alternatively, the interlock may allow product to enter the customized container, but prevent the product from exiting the container as intended if an analysis of the cap indicates that it is not an acceptable unique identifier.

Aspects of the invention may implement the unique identifier and appropriate sensor in different ways. As mentioned above, the unique identifier may be included in a cap or lid of a container holding a product desired to be placed in the customizable container of the invention. Alternatively, a unique identifier may be placed on a removable sticker that can be removed from the container holding the desired product and placed near or on the customizable container for sensing. Another option would be to place the unique identifier on the container of the desired product in a position that may be sensed with a sensor on the customizable bottle. Current technology would also allow a unique identifier to be contained in the product itself that is desired to be placed in the customizable container. In some aspects of the invention, the customizable container may include a system for performing spectrometry on the material desired to be contained within the customizable container. Another aspect of the invention may incorporate nanotechnology to provide a unique identifier for selective activation of the customizable container's interlock device.

A clever individual may attempt to circumvent the technology of the interlock system for a new supply of product by reusing the unique identifier for a previous supply of product. For example, in an aspect of the invention where the unique identifier is contained in a cap, an individual may save the cap and use it to operate the interlock again the next time it is desired to fill the customizable container. Therefore, a further aspect of the invention includes a memory in the customizable container that will record a value for a unique identifier at the time the sensor senses it. Part of the later analysis which determines whether a unique identifier is acceptable will also include comparing the unique identifier to the values stored in that memory. If the unique identifier had already been used, then an instruction to open the interlock would not be provided. As can be appreciated, the system could alternatively be designed to allow a limited number of uses for a particular unique identifier as well. Unique identifiers could also expire if they are not used within a certain period of time, or can only be used repeatedly for a certain period of time.

Similarly, another aspect of the invention which would serve to prevent circumvention of the interlock by reusing the same unique identifier at least a second time, would be to disable the unique identifier itself upon its use.

Aspects of the invention may utilize various types of containers. Additionally, the contents of the containers can also vary greatly. For example the customizable container may include bottles, sealable bags, hydration packs, sealable boxes, and other containers of various shapes and sizes. The contents may be liquid or pourable solids.

In addition to the exemplary aspects described above, further aspects of the invention will become apparent by reference to the accompanying drawings forming a part of this specification wherein like reference characters designate corresponding parts in the several views.

### BRIEF DESCRIPTION OF THE DRAWINGS

Before explaining the disclosed aspects of the present invention in detail, it is to be understood that the invention is not limited in its application to the details of the particular arrangement shown, since the invention is capable of other aspects. Exemplary aspects are illustrated in referenced figures of the drawings. It is intended that the aspects and figures disclosed herein are to be considered illustrative rather than limiting. Also, the terminology used herein is for the purpose of description and not of limitation.

FIG. 1 is an illustration of an aspect of the method of the invention showing a unique identifier being sensed and causing an interlock to open or not open.

FIG. 2 is an illustration of an aspect of the method of the invention showing a unique identifier being sensed or failing to be sensed.

FIG. 3 is an illustration of an aspect of the method of the invention utilizing a unique identifier contained in a cap.

FIG. 4 is an illustration of an aspect of the method of the invention including attaching the container to fitness equipment.

FIG. 5 is an illustration of an aspect of the method of the invention utilizing a unique identifier contained on an adhesive.

FIG. 6 is an illustration of an aspect of the method of the invention where the contents are placed in the customizable container and the interlock controls whether it may be removed from the container.

FIG. 7 is an illustration of an aspect of the method of the invention where the customizable container is a bottle.

FIG. 8 is an illustration of an aspect of the method of the invention showing a second unique identifier being utilized to operate the interlock device, the second unique identifier while intended to be unique may be rejected because it is the same as the first.

FIG. 9 is an illustration of a container/bottle with a sensor and an interlock device and a container/bottle with a unique identifier.

FIG. 10 is an illustration of a bottle with an interlock device and a port for attaching a bottle cap with a unique identifier and a bottle with a cap containing a unique identifier.

FIG. 11 is a block diagram of an exemplary aspect of the invention.

FIG. 12 is a block diagram of an exemplary aspect of the invention.

FIG. 13 is an illustration of a container/bottle with a sensor an interlock device, and a timer and a container/bottle with a unique identifier, contents, and a cap with a sensor and timer

FIG. 14 is an illustration of an aspect of the method of the invention showing a biometric characteristic being sensed and analyzed prior to the operation of an interlock.

FIG. 15. is an illustration of an aspect of the method of the invention showing a timer being used its result being analyzed prior to the operation of an interlock.

### DETAILED DESCRIPTION OF THE DRAWINGS

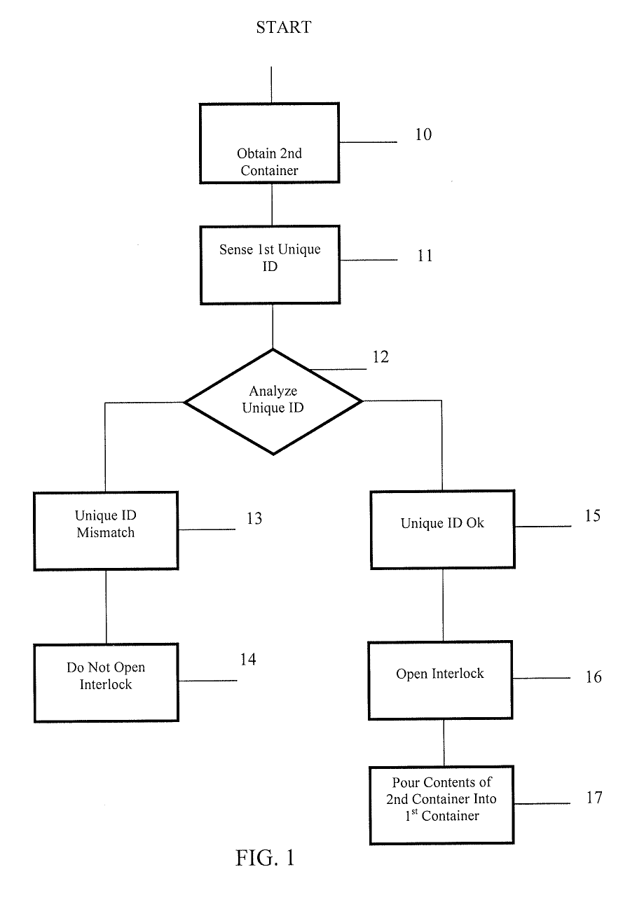

One aspect of the invention is illustrated in FIG. 1 and is a method for use with a first container. The first container comprises a sensor and an interlock device. The method comprises the step 10 of obtaining a second container. The second container comprises a first unique identifier (ID) and has contents. The method further comprises step 11 of sensing the first unique identifier of the second container with the sensor of the first container. The first unique identifier of the second container is analyzed in step 12 and yields a first result. Based on the first result, the method further comprises step 13 of providing an instruction to the interlock device. If the unique identifier does not match a predetermined set of acceptable values as in step 13 of the flowchart of FIG. 1, an interlock device on the first container remains closed and does not open to allow contents from the second container to be poured into the first container. This is shown in step 14 of FIG. 1. If the unique ID does match a predetermined set of acceptable values as in step 15 of FIG. 1, the interlock device of the first container opens as shown in step 16 of FIG. 1 and the contents of the second container may be poured into the first container. This is shown in step 17 of FIG. 1.

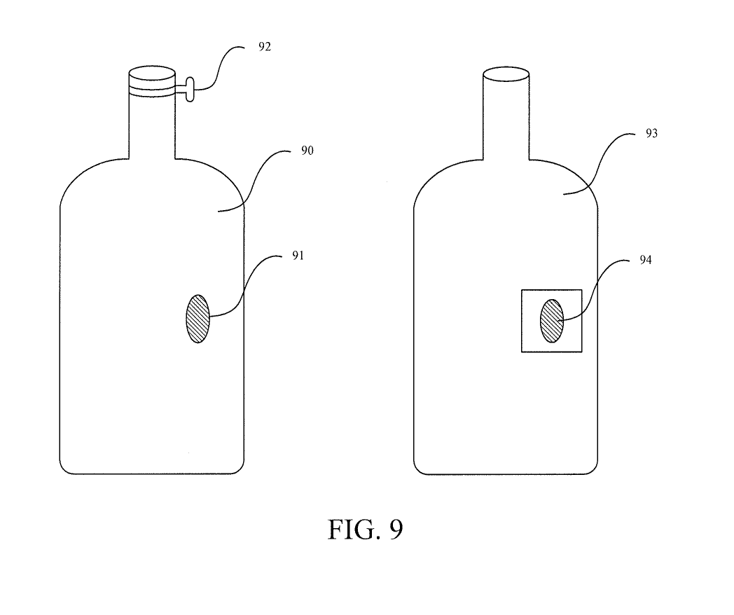

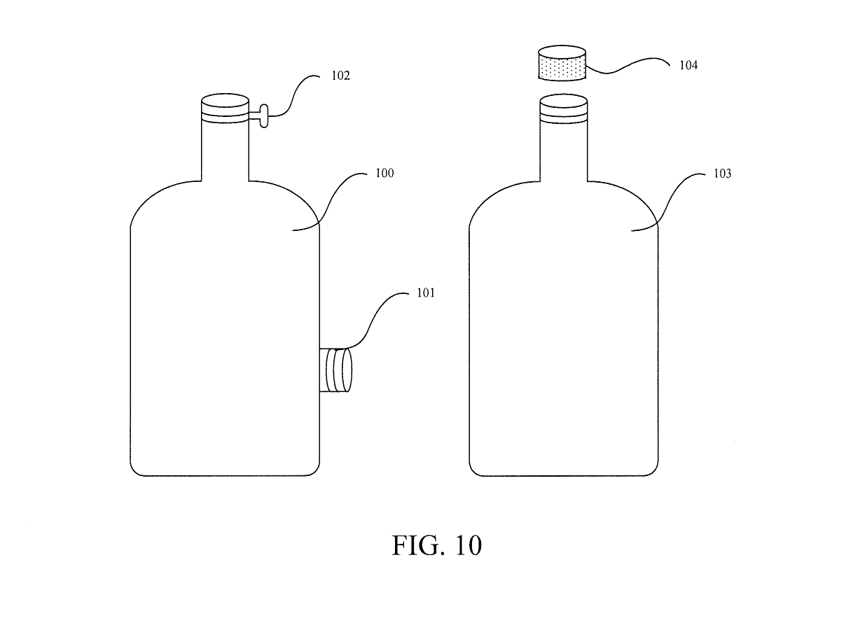

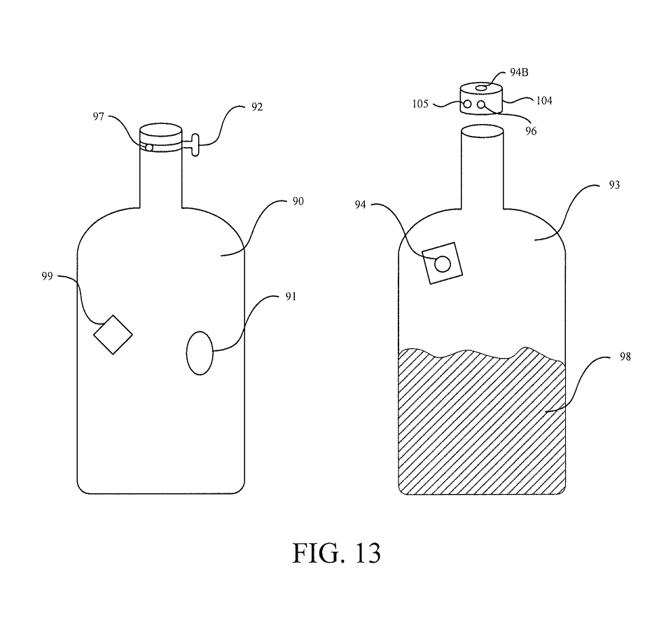

In an exemplary aspect of the current invention, the first container may be a bottle, an Example of which is shown in FIG. 9, FIG. 10, and FIG. 13. Although bottles may come in a large variety of shapes and sizes, in general a bottle is a vessel, often of glass and typically cylindrical with a narrow neck that can be closed with a cap or cork, for containing liquids. These liquids may include a beverage, an electrolyte replacement beverage, a medication, a drug, a nutritional supplement, liquid bath soap, hair shampoo, hair conditioner, laundry soap, dishwashing soap, and a number of additional other liquids. In addition to liquids, it can be appreciated that bottles and containers in general also could contain pourable solids such as a powder, pet food, medication, drugs, nutritional supplements, vitamins, candy, gum balls, novelty items, pills, pet litter, flour, sugar, spices, and laundry soap flakes and a myriad of other small items.

It should be appreciated that in some aspects of the invention, the first container of the invention may be a bottle and the second container is a “container”. In other aspects, both containers may be bottles as shown in FIG. 9 and FIG. 10. In other aspects, it would be possible for the second container to be a bottle and the first container to be a container.

The containers or bottles of various aspects of the invention may be made of glass; polycarbonate, high density polyethylene, Nalgene, or other plastics; stainless steel, aluminum, or other metals; or other appropriate materials that would prevent the contents from escaping. An exemplary container may be what is commonly referred to as a hydration pack, such as those sold under the trademark Camelbak™. Such hydration packs usually include a flexible bladder that can hold a liquid, and the bladder is often incorporated into a backpack device commonly used by hikers, skiers, and bikers.

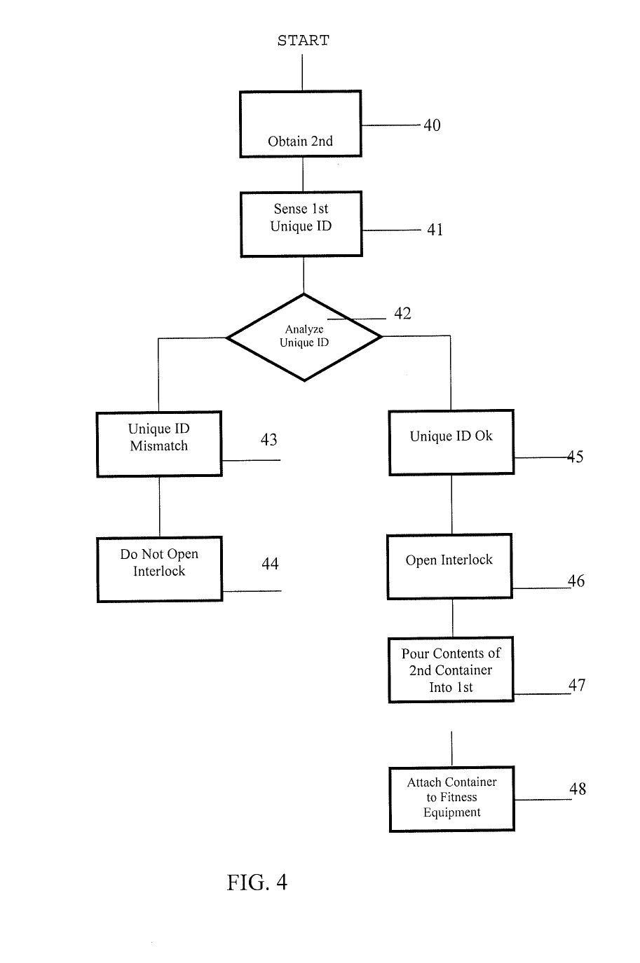

In some aspects of the invention, the first container is a bottle that is attachable to fitness equipment and may be attached to fitness equipment such as a bicycle. An example of this is shown in FIG. 4, where after steps 40-47 are performed similarly to the steps shown in FIG. 1, the container/bottle is attached to fitness equipment in step 48.

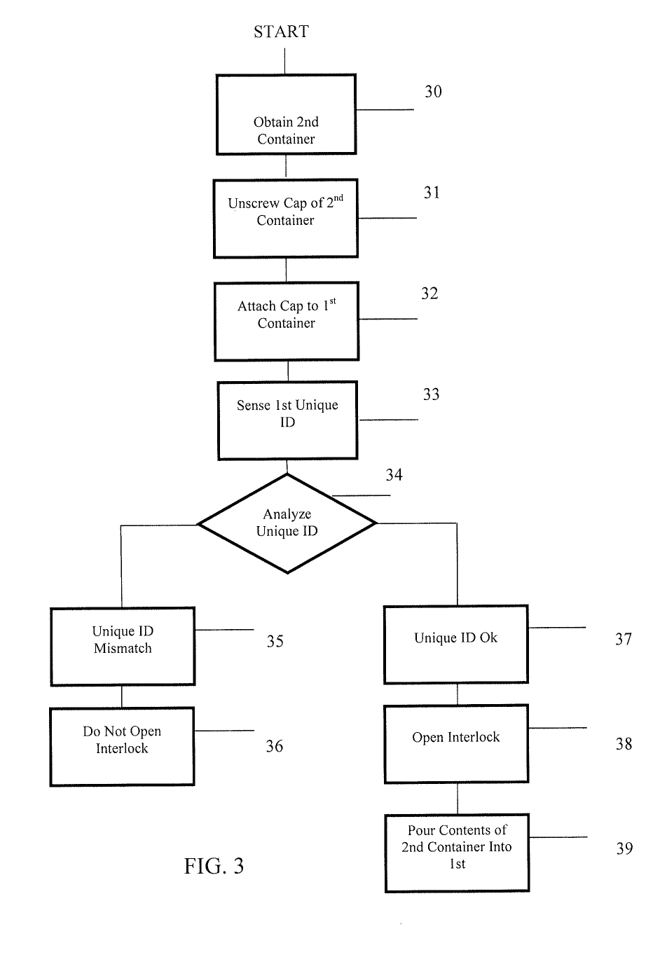

An additional aspect of the invention is shown in the steps illustrated in FIG. 3 and the apparatus of FIG. 10. In this exemplary aspect of the invention, the unique identifier of the second container 103 is located in the cap 104 of the second container 103 or bottle. In step 31, the cap 104 of the second container 103 is unscrewed and removed from the second container 103 and is attached to the sensing port 101 of the first container 100 in step 32. It also could be held in close proximity to the sensor of the first container, even if the first container does not provide a port for reattaching the cap. The unique identifier is analyzed in step 34. If the unique identifier does not match a predetermined set of acceptable values as in step 35 of the flowchart of FIG. 3, an interlock device 102 on the first container 100 remains closed and does not open to allow contents from the second container 103 to be poured into the first container 102. This is shown in step 36 of FIG. 3. If the unique ID does match a predetermined set of acceptable values as in step 37 of FIG. 3, the interlock device 102 of the first container opens as shown in step 38 of FIG. 3 and the contents of the second container 103 may be poured into the first container 100 as shown in step 39 of FIG. 3 and in the apparatus of FIG. 10.

In some aspects of the invention, the step of unscrewing the cap of the second container and attaching the cap to the first container occurs prior to sensing the first unique identifier. In other aspects of the invention, the step occurs after the unique ID was sensed.

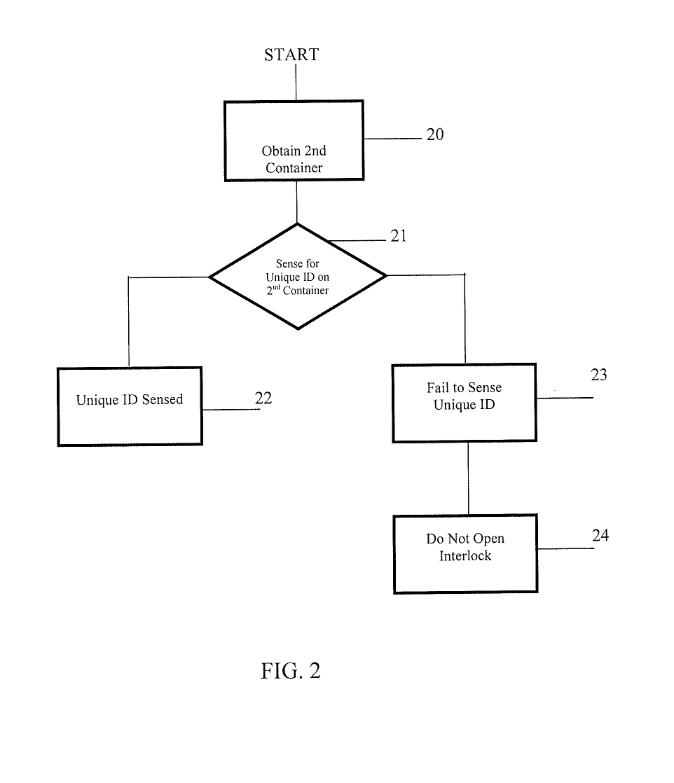

FIG. 2. illustrates an additional aspect of the method of the invention. Here as in some cases, the second container may not contain a unique identifier to sense or the unique identifier becomes corrupted or lost. In this case, and as shown in steps 20-24 of FIG. 2, if an attempt is made to sense the unique ID as shown in step 21, and nothing is sensed as shown in step 23, then the interlock will not open as shown in step 24. Therefore the interlock prevents the contents from the second container from entering into the first container.

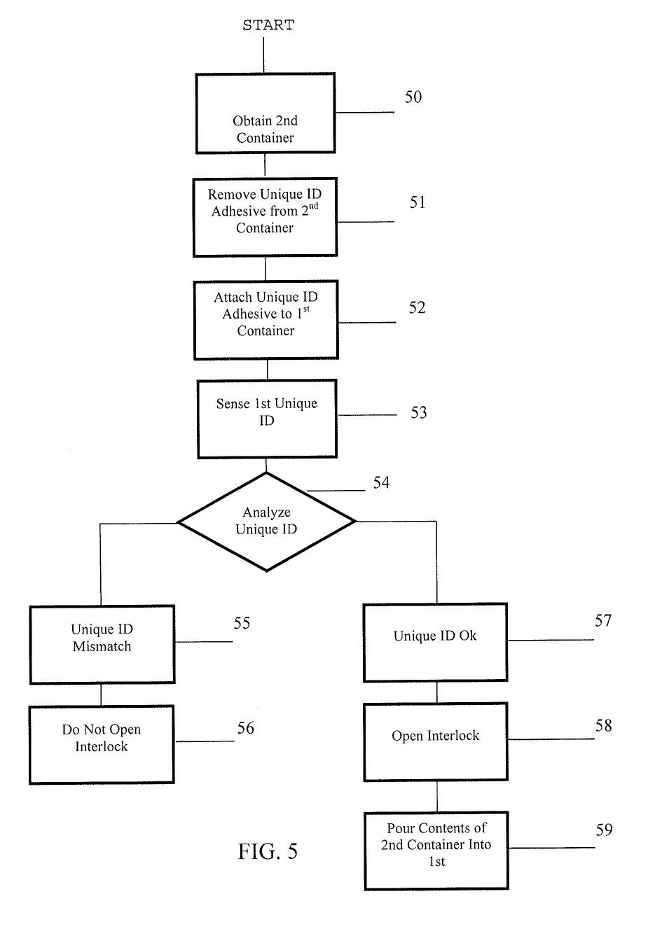

Similarly to what was shown in FIG. 3, another exemplary aspect of the invention is shown in FIG. 5. Here, the first unique identifier is attached to the second container with a removable adhesive. In step 51 the first unique identifier is removed from the second container prior to sensing the first unique identifier. In some cases and as shown in step 52 the removable adhesive may be reused to attach the first unique identifier to the first container prior to sensing the first unique identifier. In other cases it may be possible to simply place the removable adhesive in close proximity to the sensor of the first container. The first unique identifier is then sensed as indicated in step 53, and analyzed as in step 54. If the unique identifier is a mismatch as shown in step 55, then the interlock is not opened as shown in step 56. If the unique identifier is a match as shown in step 57, then the interlock is opened as shown in step 58 and the contents of the second container may be poured into the first container as shown in step 59.

An exemplary apparatus of the method described in FIG. 5 and above is shown in FIG. 9. FIG. 9 illustrates a first container 90 or bottle having a sensor 91 and an interlock device 92. FIG. 9 also shows a second container 93 containing a unique identifier 94 which may be removably attached, for example with a reusable adhesive. The unique identifier may also be permanently attached to the second container.

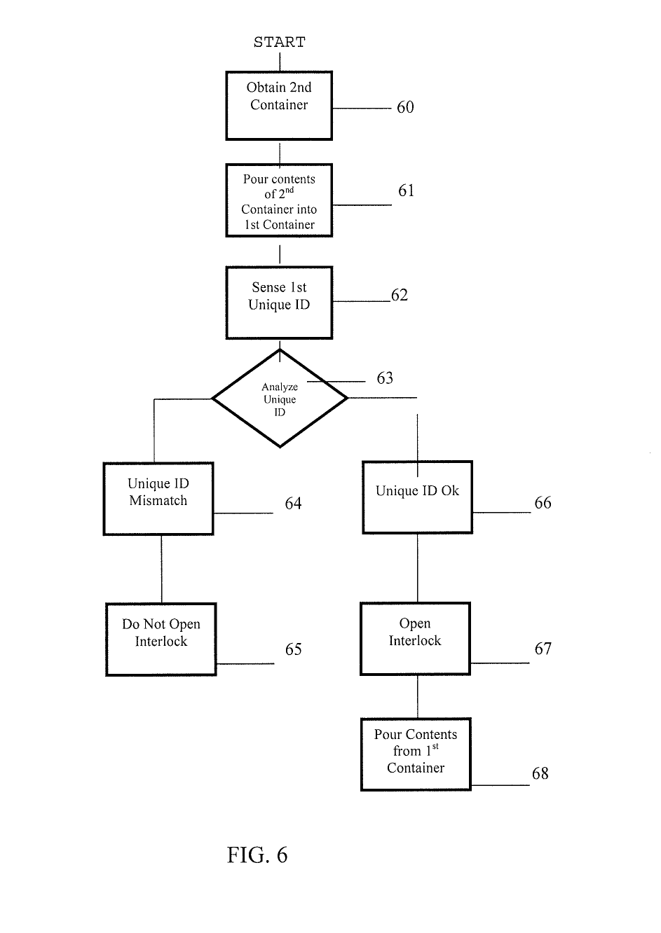

Another aspect of the invention is illustrated by the steps shown FIG. 6. The method of this aspect of the invention is for use with a first container. The first container comprises a sensor and an interlock device. In step 60 a second container is obtained. The second container comprises a first unique identifier and has contents. The contents, as described in various forms in other aspects of the invention might be liquid or a pourable solid. The contents of the second container are poured into the first container in step 61. The first unique identifier of the second container is sensed with the sensor of the first container in step 62. In step 63 the first unique identifier of the second container is analyzed. The analysis may compare the unique identifier to a list of acceptable identifiers. The result of the analysis is provided in the form of instruction to the interlock device based on the first result, and the interlock device according to the instruction. If the result of the analysis is a unique identifier mismatch 64, the interlock is not permitted to be opened as shown in step 65. Alternatively, if the result is that the ID is acceptable 66. Then the interlock can be opened as in step 67 and the contents will be permitted to be poured out of the first container 68.

In another aspect of the invention, in addition to the steps shown in FIG. 6, the second container may be a bottle that has an additional specialized function beyond that of a standard bottle. For example, when the contents of the bottle are poured out of the bottle, the bottle may measure how much content passes through the opening. It could also be that the content of the bottle was also measured as it was poured into the bottle from a first container. In this aspect of the invention, it may be that the opening and closing of the interlock does not necessarily relate to whether the liquid or pourable solid is permitted to pass through the opening of the bottle, but could mean in an alternate embodiment that the interlock gives functionality to the device which measures the input and output of the bottle. For example, if the ID is not appropriate, then the measuring device would not provide any information, if the ID is deemed acceptable, the device would measure either how much content goes into the bottle or how much content exits the bottle, or both.

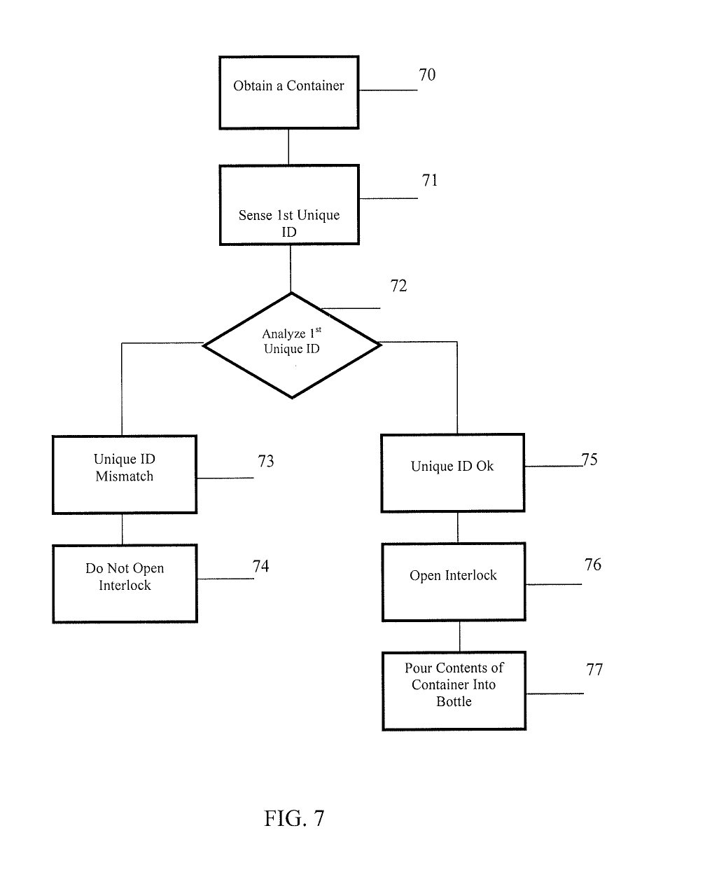

FIG. 7 illustrates an aspect of the method of the invention which is a method for use with a bottle. The bottle comprises a sensor and an interlock device. In step 70, a container is obtained. The container comprises a first unique identifier and has contents. The contents as described in other aspects of the invention may include various liquids or pourable solids. Step 71 is sensing the first unique identifier of the container with the sensor of the bottle. The first unique identifier of the container is analyzed in step 72 yielding a first result. Based on the first result an instruction is provided to the interlock device. The interlock device is operated according to the instruction. If, as in 73, the unique identifier is considered unacceptable, the interlock does not open as shown in 74. If as in 75, the unique identifier is acceptable, the interlock opens as shown in step 76. A result of the interlock opening or not either permits contents from the container to enter into the bottle or prevents contents from the container from entering into the bottle. Depending on the functionality of the bottle, the interlock may permit or prevent other uses of the bottle as well, in addition to whether or not contents may be added to the bottle.

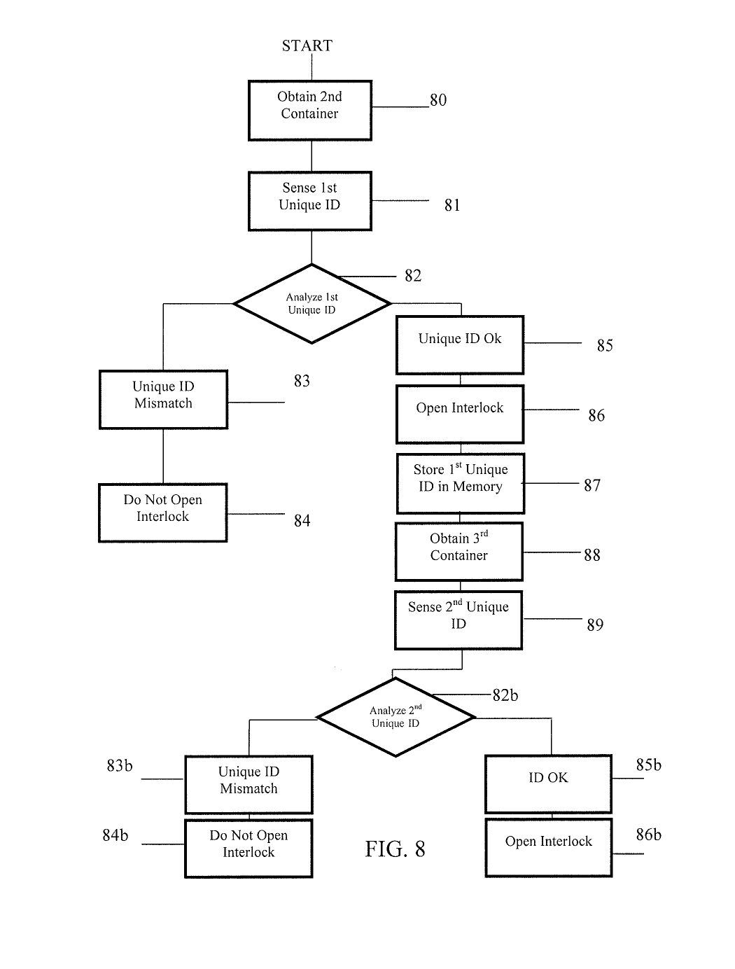

FIG. 8 shows an aspect of the method of the invention for the purpose of preventing the reuse of the unique identifier of a second container to activate the interlock of the first container a second time. In this aspect of the invention, the first container comprises a sensor and an interlock device. Additionally, the first container is communicatively coupled to a writeable memory. In this aspect of the invention, the first container may be a bottle. The method comprises the step 80 of obtaining a second container. The second container comprises a first unique identifier and has contents. The method further comprises the step 81 of sensing the first unique identifier of the second container with the sensor of the first container. The method further comprises the step 82 of analyzing the first unique identifier of the second container and yielding a first result. Based on the first result, the method further comprises the step of providing an instruction to the interlock device. If the unique ID does not match a predetermined set of acceptable values as in step 83 of the flowchart of FIG. 8, an interlock device on the first container remains closed as shown in step 14 of FIG. 8. If the first unique ID does match a predetermined set of acceptable values as in step 85 of FIG. 8, the interlock device of the first container opens as shown in step 86 of FIG. 8. The method shown in FIG. 8 further comprises the step 87 of storing a value relating to the sensed first unique identifier in the writable memory of the first container. In step 88a third container is obtained. The third container comprises a second unique identifier and has contents. The second unique identifier of the third container is sensed in step 89 with the sensor of the first container. Step 82b analyzes the second unique identifier of the third container. This analysis includes comparing the second unique identifier with the stored value of the first unique identifier and yielding a second result. The method of the invention then provides a second instruction to the interlock device based on the second result. If the second unique identifier is not acceptable as shown in step 83b, then the interlock does not open as shown in step 84b. The contents from the third container would be prevented from entering into the first container. If the second unique identifier is acceptable as shown in step 85b, then the interlock is opened as shown in step 86b. The open interlock would permit contents from the third container to enter into the first container. If a user attempts to reuse the first unique identifier instead of obtaining a third container with a second unique identifier (or for some reason the first unique identifier has the same value as the second unique identifier) after the interlock of the container has been opened in step 86, then the analysis 82b would yield an instruction to the interlock device that the identifier was unacceptable due to it matching the first sensed unique identifier and the interlock would not open.

Another aspect of the invention for preventing multiple uses of the same unique identifier is if the unique identifier comprises properties which modify the unique identifier once the unique identifier is sensed with a first container. For example, the value the unique identifier could be modified is a value that would cause the unique identifier to be deemed unacceptable when analyzed. This would result in an instruction to the interlock device that it should not be opened. It should be appreciated that an alternative aspect of the method of the invention would allow a unique identifier to be used more than once, but could at a specific time be disabled for further use either by configuring the bottle to allow use of a unique identifier for a set number of times or modifying the unique identifier to an unacceptable value after a certain number of uses or times that it is sensed. In yet another aspect of the invention, either the first container or the first unique identifier could be configured with an expiration time and/or date related to a certain time when either the first container or the first unique identifier is modified so that the analysis would yield an instruction to the interlock device preventing it from opening.

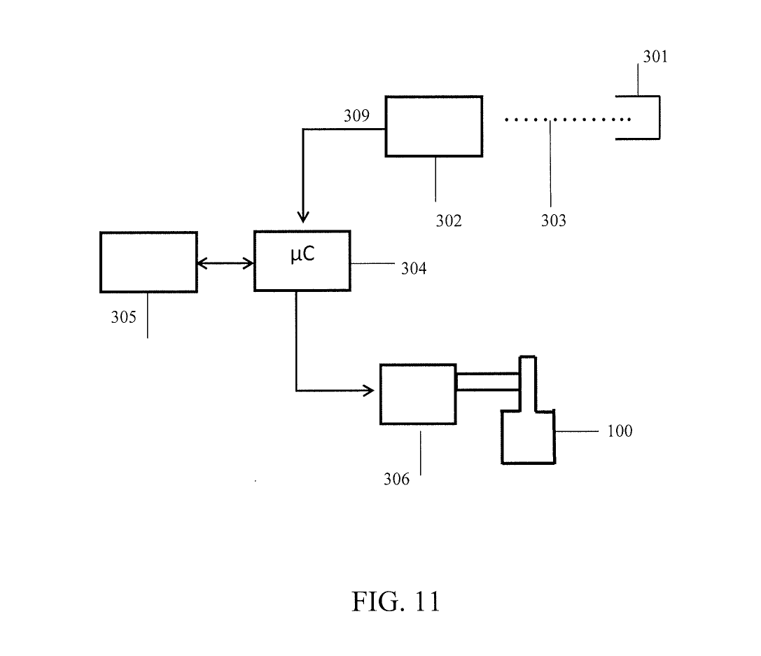

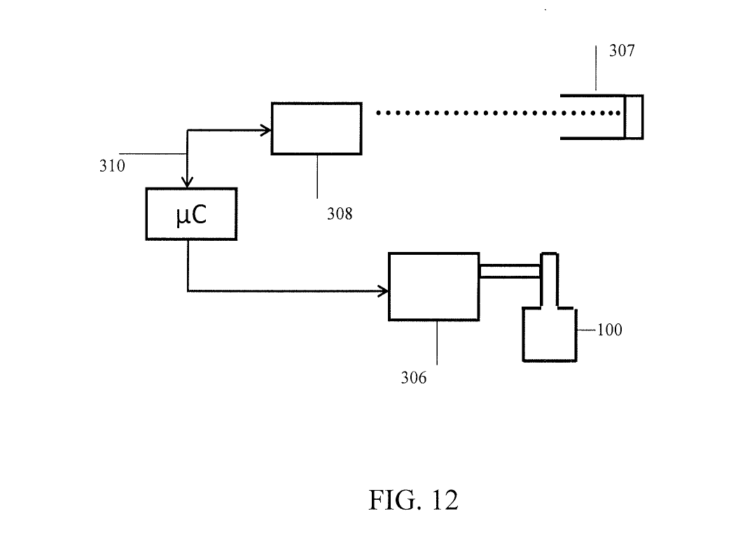

Turning now to FIGS. 11 and 12, it is instructive to consider particular physical structures which might be employed to bring about the ends set forth above.

In FIG. 11 we see a bottle cap 301 juxtaposed with a sensor 302 by a linkage 303. In an exemplary aspect of invention, the linkage is that the bottle cap 301 bears a bar code or other optically readable code, and the sensor is a bar code reader or other optical code reader. The alert reader will of course appreciate that the linkage could instead, for example, in another aspect of the invention, be an RFID chip in the bottle cap 301 and a near-field communications sensor or other RFID sensor 302. Other linkages 303 could likewise be employed. In this system, the sensor 302 senses some unique identifier and passes it through communications line 309 to microcontroller 304. Microcontroller 304 then consults a memory 305 of unique identifiers which had been consumed in the past. If the current unique identifier does not match any identifier in the memory 305, then this serves as an affirmative finding (see for example box 15 in FIG. 1) and the microcontroller then activates interlock 306 which is connected with a neck or opening of bottle 100.

Memory 305 is, in the simplest case, simply stored within the system as depicted. In an alternative aspect of the invention, the microcontroller 304 could be communicatively coupled with a distant host which in turn maintains the memory 305.

In FIG. 12 we see a bottle cap 307 juxtaposed with an actuator 308. The bottle cap 307 contains some internal state such as a fusible link. In an exemplary aspect of the invention, the state to be stored is that the bottle cap 301 contains a fusible link. The alert reader will of course appreciate that the linkage could instead for example in another aspect of the invention be modeled after well-known antitheft tags which are deactivated by juxtaposition with a strong magnet or are deactivated by a strong RF or magnetic field. Other linkages 303 could likewise be employed. In this system, the sensor 308 not only changes the stored state of the cap 307 but also communicates to microcontroller 304 that it has done so. Microcontroller 304 then activates interlock 306 which is connected with a neck or opening of bottle 100.

Alternatively the juxtaposition of the cap 307 with the actuator 308 fails to bring about a change of the internal state (for example the fusible link has already been blown in the past). This serves as a negative finding (see for example box 23 in FIG. 2) and the interlock 306 is not activated.

One may thus appreciate that some sort of storage of a state is required so as to avoid the unwanted result of a user achieving more activations than were intended to be associated with a particular cap 307. One place to store the state is, as depicted in FIG. 12, in the cap. Another place to store the state is, as depicted in FIG. 11, in a memory 305 that is communicatively coupled with microcontroller 304.

The simple case is the case where the number of activations per cap 307 is one. But it is also possible to permit some other number, for example with a cap 307 which permits two activations but not three.

Aspects of the invention include systems as well as individual components. In one aspect of the invention, as shown in FIG. 9 a first container 90 comprises a sensor 91 communicatively coupled to an interlock device 92. This aspect also includes a second container 93. The second container comprises a first unique identifier 94 which is capable of being sensed by the sensor 91. The second container has contents which may include but is not limited to the various contents described above for other aspects of the invention. The interlock device 92 of the first container is operational based on the first unique identifier 94 of the second container 93. In some aspects of the invention, a cap 104 as shown in FIG. 10 from the second container comprising the first unique identifier 94. An exemplary cap 301 is also shown in FIG. 11 and is further described above. In other aspects of the invention, a removable adhesive comprises the unique identifier. In some aspects of the invention the first container may or may not be a bottle and the second container may or may not be a bottle. As can be appreciated, in various aspects of the invention, it is the interlock device of the first container that is intended to control the transferability of the contents of the second container into the first container, the transferability of the contents of the second container out of the first container, or the transferability of the contents of the second container into and out of the first container.

An aspect of the invention may be directed toward a single container. In this aspect which can be seen in FIG. 9, a container comprises a first sensor 91 communicatively coupled to an interlock device 92. The sensor 91 is capable of sensing a unique identifier from a second container. The interlock device 92 of the container is operational based on the unique identifier of the second container.

Another aspect of the invention may be directed towards a cap such as the one shown in FIG. 13. In one aspect, the cap 104 comprises a unique identifier 94B and is attachable to a container 93 having contents 98. The unique identifier 94B is capable of being sensed by a sensor on a second container and analyzed yielding a result. An interlock device on the second container is operational based the result from the analysis. In other aspects of the invention, the cap 104 may also comprise a biometric or other sensor 105 or a timer 96.

In another aspect of the invention a container 93 comprises first unique identifier 94 and has contents 98. The first unique identifier 94 is capable of being sensed and has a value. Whether an interlock device on a second container 90 is operational depends on the value of the first unique identifier. In another aspect, a container 103 of the invention further comprises a cap 104, the cap comprising the unique identifier 94B.

Additional interlocks, additional sensors and additional controls for a single interlock are beneficial in some aspects of the invention. For example, it may be desirable to incorporate a pressure sensor into an aspect of the invention. The pressure sensor would work in conjunction with the interlock device creating a “child proof” lock which may prevent a child from ingesting potentially dangerous contents from the containers of the invention. In this aspect of the invention a bottle or container comprising a pressure sensor communicatively coupled with interlock device would only allow operation of the interlock under certain pressure, for example a level of pressure that a child would be unlikely to be able to apply. The pressure sensor may be located, for example, in a cap, the interlock device, or as a separate stand-alone sensor. An interlock on a container generally may become operational if adequate pressure is applied to a sensor, another recognized unique identifier is sensed, or a combination of the two. An exemplary aspect of the invention involving a pressure sensor, referred to more broadly as a “biometric sensor” or “biometric reader” follows.

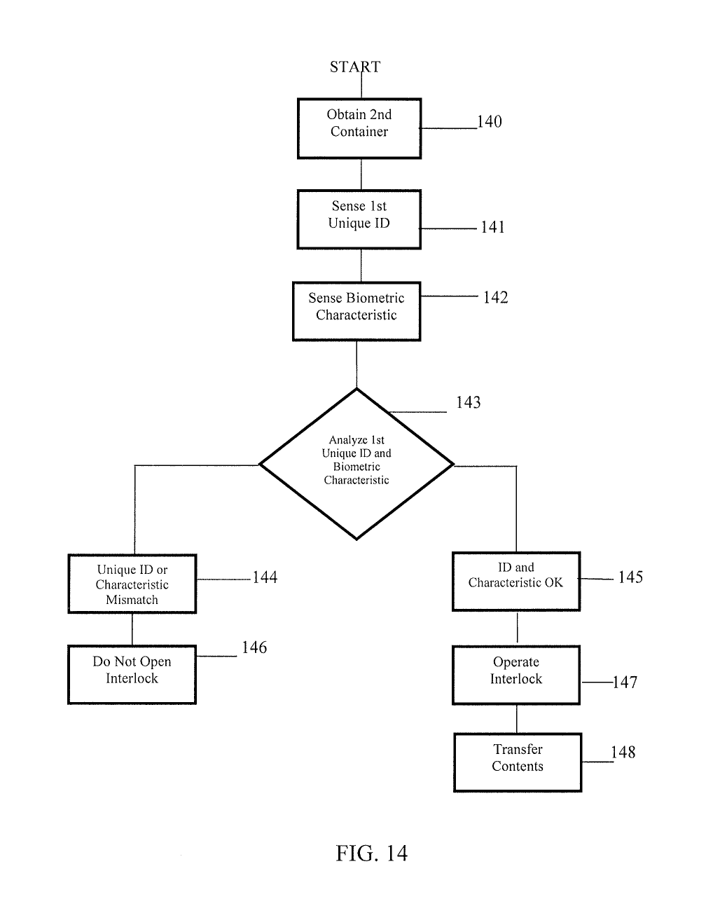

In this aspect of a method of the invention, illustrated in FIG. 13, a first container 90 comprises a first sensor 91, a second sensor 99, and an interlock device 92. The second sensor 99 is a biometric sensor. Exemplary biometric sensors include but are not limited to those which sense pressure, finger prints, eye characteristics, and other Physiological and Behavioral characteristics. This exemplary aspect of the method of the invention includes the following steps which are shown in FIG. 14. Obtain a second container 140. As with other aspects of the invention, the second container comprises a first unique identifier and has a contents. Sense the first unique identifier of the second container with the first sensor of the first container 141. Analyze the first unique identifier of the second container, yielding a first result 143. Sense a biometric characteristic with the second sensor 142. Analyze the biometric characteristic and yield a second result 143. Provide an instruction to the interlock device based on the first and second results 144 and 145. Operate the interlock device in a manner of operation according to the instruction 146 and 147. This exemplary method of the invention may further comprise the step of pouring the contents of the second container into the first container 148. The manner of operation may permit the contents from the second container to exit the first container. As mentioned previously, the second sensor could be a pressure sensor and the biometric characteristic sensed and analyzed may be the amount of pressure applied to the biometric sensor.

A system complementary to the method of the invention described above is shown at least in FIG. 13 and comprises a first container 90 with a first sensor 91, a second sensor 99, and an interlock device 92 communicatively coupled to the first and second sensors. In this aspect of the invention, the second sensor 99 is a biometric sensor. The system further may comprise a second container 93 comprising a first unique identifier 94 capable of being sensed by the first sensor 91 and having contents 98. The interlock device 92 is operational at least based on the first unique identifier 94. In this aspect of the invention, it may also be based on what is sensed with the biometric sensor 99. It should be appreciated that the second container 93 may further comprise a cap 104 which comprises an alternate first unique identifier 94B.

An alternative version of the system above, also shown in FIG. 13, would be to put an alternative biometric or other type of sensor 105 in the cap from the second container. This aspect of the invention comprises a first container 90 comprising a first sensor 91 and an interlock device 92. It further comprises a second container 93 comprising a first unique identifier 94 capable of being sensed by the first sensor 91. The second container 93 further comprises a cap 104 which has a second sensor 105 and contents 98. In this aspect of the invention, the interlock device 92 is communicatively coupled to the first 91 and second sensors 105. As previously mentioned, the second sensor 105 may be a biometric sensor. The interlock device 92 is operational based on the first unique identifier 94 and information obtained by the biometric sensor 105 or other type of sensor. As can be appreciated, the biometric sensor 105 can be a pressure sensor and may or may not be programmable. The cap 104 in this aspect of the invention may also comprise the unique identifier 94B.

It may be desirable to limit the consumption of the contents of a bottle 91 to certain periods of time. An example would be if the bottle contained medication that would harm the user if too much was taken at once. It could be the case that the interlock allowed only a certain volume to exit and then would only allow further volume to exit after a specific amount of time passed. It could also be the case that the user was in control of how much liquid was removed at a given time, but that a certain amount of time would need to pass before additional liquid could be removed. This feature may be particularly helpful to users that are very forgetful, perhaps because they are suffering from Alzheimer's disease.

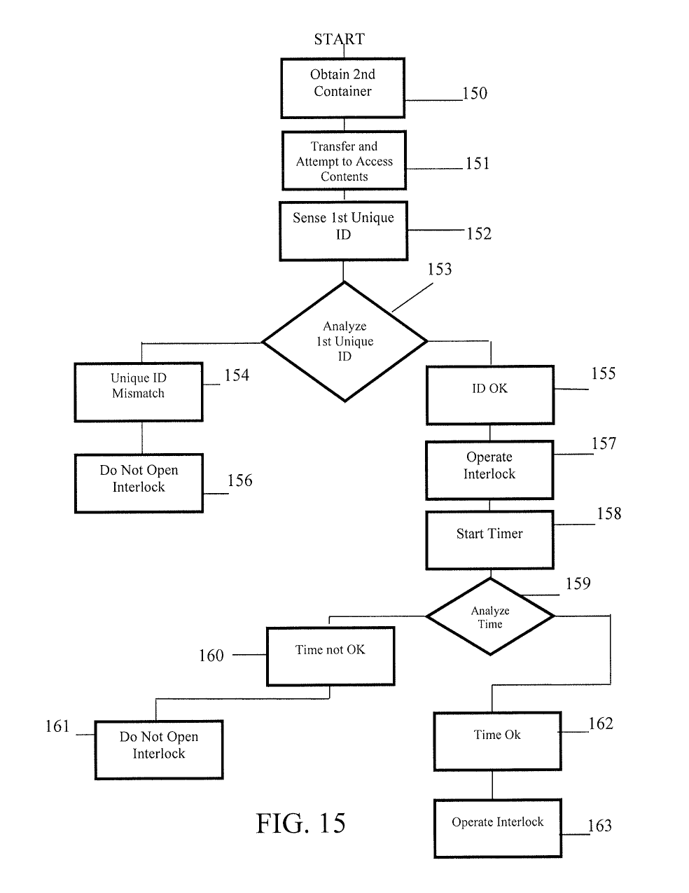

An aspect of the invention controlling the interlock of a bottle with a timer is illustrated in FIG. 15. It is a method for use with a first container comprising a first sensor and a timer communicatively coupled to an interlock device. The timer may or may not be programmable. The method comprises the following steps. Obtain a second container comprising a first unique identifier and having contents 150. Pour at least some of the contents of the second container into the first container 151. Sense the first unique identifier with the sensor 152. Analyze the first unique identifier and determine a first result 153. Provide a first instruction to the interlock device based on the first result 154 and 155. Operate the interlock device according to the first instruction 156 and 157. If the first operation of the interlock device permits contents from the second container to exit the first container a timer will either automatically start after at least some of the contents exits the first container, or the timer should be manually started 150. Allow time to pass. Determine how much time passed since the first operation of the interlock device with the timer 159. This determination yields a second result. Provide a second instruction to the interlock device based on the second result 160 and 162. Operate the interlock device according to the second instruction 161 and 163. In one aspect of the invention, as shown in FIG. 13, the interlock device comprises the timer 97. Alternatively, the second container could further comprise a cap and the cap comprises the first unique identifier. The cap may also alternatively comprise the timer. In another aspect of the invention, the system may also utilize the timer to control how long the interlock remained open before it closed again.

Another aspect of the invention illustrated in FIG. 13 comprises a first container 90 comprising a sensor 91 communicatively coupled to an interlock device 92, and a memory such as memory 305 shown in FIG. 11. This aspect of the invention further comprises a second container 93 comprising a first unique identifier 94 capable of being sensed by the sensor 91. The second container has contents 98. This aspect of the invention further comprises a third container (not shown but similar to second container 98) having a second unique identifier capable of being sensed by the sensor, and also has a contents. The interlock device 92 of the first container 90 is initially operational based on the first unique identifier 94. Then, if a user decides to attempt to use the first container 90 at least a second time with, for example, a third container, it is operational based on an outcome of an analysis of whether the first unique identifier and second unique identifiers are non-identical.

The alert reader will readily appreciate that while the invention is disclosed with respect to the structure set forth above, one could readily substitute many obvious variants and improvements without deviating in any way from the teachings of the invention. Thus for example while a microcontroller is depicted, it would be possible to use a microprocessor with associated circuitry and devices. Likewise one could use application-specific integrated circuits or field-programmable gate arrays, or even random logic, to accomplish the ends set forth above.

In other exemplary aspects of the invention, the container may be something other than a bottle. As described above, exemplary containers may include bottles, sealable bags, hydration packs, sealable boxes, and other containers of various shapes and sizes. In addition, and as described in exemplary aspects above, cap 307 as illustrated in FIG. 11 and FIG. 12 could be interchanged with a removable adhesive, or could be something permanently affixed to a second container.

While a number of exemplary aspects of the invention have been discussed above, the alert reader will recognize certain modifications, permutations, additions and sub-combinations therefore. Each apparatus aspect described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred aspects and optional features, modification and variation of the concepts herein disclosed may be resorted to by the alert reader, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and known contexts. The above definitions are provided to clarify their specific use in the context of the invention.

1-23. (canceled)

24. An apparatus comprising:
a first container comprising a sensor communicatively coupled to an interlock device; and
a second container comprising a first unique identifier capable of being sensed by the sensor, the second container having contents;
wherein the interlock device of the first container is operational based on the first unique identifier.

25. The apparatus of claim 24 wherein the second container further comprises a cap, the cap comprising the first unique identifier.

26. The apparatus of claim 24 wherein the first container is a bottle.

27. The apparatus of claim 24 wherein the first and second containers are bottles.

28. The apparatus of claim 24 wherein the second container further comprises a removable adhesive, the removable adhesive comprising the first unique identifier.

29. An apparatus comprising:
a first container comprising a first unique identifier and a contents;
wherein the first unique identifier is capable of being sensed and has a value;
wherein the value of the first unique identifier is configured to determine whether an interlock device on a second container is operational.

30. The apparatus of claim 29 wherein the first container further comprises a cap, the cap comprising the unique identifier.

31. The apparatus of claim 29 wherein the first container further comprises a removable adhesive, the removable adhesive comprising the unique identifier.

32-34. (canceled)
